(19) United States
(12) Patent Application Publication
(10) Pub. No.: US 2026/0046248 A1
(43) Pub. Date: Feb. 12, 2026

(54) SYSTEM AND METHODS FOR ROUTING DOWNLINK DATA PACKETS IN A THREAD NETWORK

(71) Applicant: SAMSUNG ELECTRONICS CO., LTD., Suwon-si (KR)

(72) Inventors: Manjunath Neelappa SATARADDI, Bangalore (IN); Bahubali Bommanna GUMAJI, Bangalore (IN); Kumar MURUGESAN, Bangalore (IN); Sangsoo LEE, Suwon-si (KR); Tirth MASTER, Bangalore (IN); Vedansh BHARDWAJ, Bangalore (IN)

(73) Assignee: SAMSUNG ELECTRONICS CO., LTD., Suwon-si (KR)

(21) Appl. No.: 19/360,379

(22) Filed: Oct. 16, 2025

Related U.S. Application Data
(63) Continuation of application No. PCT/KR2024/004899, filed on Apr. 12, 2024.

(30) Foreign Application Priority Data
Apr. 18, 2023 (IN) 202341028274
Nov. 2, 2023 (IN) 202341028274

(51) Int. Cl. H04L 45/74

(52) U.S. Cl. CPC H04L 45/74

(57) ABSTRACT

A wireless network device includes at least one processor; and memory storing instructions, wherein the instructions, when executed by the at least one processor, individually or collectively, cause the wireless network device to control at least one border router to determine a shortest route path from the at least one border router to a thread node in a thread network; control the at least one border router to assign a preferred border router to the thread node based on the shortest route path; control the at least one border router to send context information in an advertisement packet to a network node, wherein the context information indicates the assigned preferred border router for the thread node; and send at least one downlink packet to the thread node through the assigned preferred border router.

### CROSS-REFERENCE TO RELATED APPLICATIONS

This application is a by-pass continuation application of International Application No. PCT/KR2024/004899, filed on Apr. 12, 2024, which is based on and claims priority to Provisional Indian Patent Application number 202341028274, filed with the Indian Patent Office on Apr. 18, 2023, and Non-Provisional Indian Patent Application number 202341028274, filed with the Indian Patent Office on Nov. 2, 2023, the disclosures of which are incorporated by reference herein in their entireties.

### BACKGROUND

### 1. Field

Embodiments disclosed herein relate to an Internet of Things (IoT) environment, and more particularly to systems and methods for routing downlink data packets in a thread network over the IoT environment.

### 2. Description of Related Art

A thread is a wireless networking protocol designed for Internet of Things (IoT) devices to work securely and efficiently without a single point of failure. The thread helps in creating and managing a thread based IoT mesh network. A thread IoT network (including all thread nodes) depends on backhaul Wi-Fi Networks for the Internet to receive control commands from a cloud and to send status updates to cloud services. A user of the IoT device may send remote IoT control commands, having a remote control operation using an application programming interface (API) via a cloud network using the Internet An example of the API is a SmartThings (ST) API. The user of the IoT device may send local IoT control commands using the user device from a local Wi-Fi Network when the user is in a IoT premises.

Thread devices in the IoT environment may communicate with each other and with cloud services directly without intermediate translation as it works based on Internet Protocol (IP). The thread network requires one or more border routers (BR) in a topology to route thread network packets to outside. The thread devices which support additional interfaces such as Wi-Fi or Ethernet, may work as a border router. For example, IoT devices such as a speaker, a refrigerator, and a television can play the border router role, wherein they support both Thread and Wi-Fi radios.

When multiple border routers are used, the thread downlink (DL) data traffic may follow a non-optimal path, and this can result in performance degradation. As IoT devices are very delay sensitive, the efficient routing of packet from an external network (such as from Wi-Fi or Internet), to the thread nodes is of much importance.

### SUMMARY

Provided are systems and methods for routing downlink data packets in a thread network.

According to an aspect of the disclosure, a wireless network device includes at least one processor; and memory storing instructions, wherein the instructions, when executed by the at least one processor, individually or collectively, cause the wireless network device to control at least one border router to determine a shortest route path from the at least one border router to a thread node in a thread network; control the at least one border router to assign a preferred border router to the thread node based on the shortest route path; control the at least one border router to send context information in an advertisement packet to a network node, wherein the context information indicates the assigned preferred border router for the thread node; and send at least one downlink packet to the thread node through the assigned preferred border router.

The instructions, when executed by the at least one processor, individually or collectively, may cause the wireless network device to control the at least one border router to assign an on-mesh prefix to the thread node; control the at least one border router to send the on-mesh prefix to the thread node; control the thread node to obtain a route path count from the at least one border router based on the on-mesh prefix; control the thread node to send information identifying the preferred border router to the at least one border router; and control the at least one border router to determine the shortest route path from the at least one border router to the thread node based on the obtained route path count.

The instructions, when executed by the at least one processor, individually or collectively, may cause the wireless network device to control the at least one border router to generate a sub-prefix by sub-netting the thread network; control the at least one border router to send the sub-prefix to the thread node; control the thread node to obtain a route path count from the at least one border router based on the sub-prefix; control the thread node to send the preferred border router to the at least one border router; and control the at least one border router to determine the shortest route path from the at least one border router to the thread node based on the obtained route path count.

The instructions, when executed by the at least one processor, individually or collectively, may cause the wireless network device to control at least one first border router to receive a routing table and a child table from at least one second border router; control the at least one first border router to obtain a route path count for the thread node from the routing table and the child table; and control the at least one first border router to determine a shortest route path from the at least one first border router to the thread node based on the obtained route path count.

The routing table may be populated with information identifying the thread node and a preferred border router for the thread node that is selected from among the at least one first border router and the at least one second border router.

The instructions, when executed by the at least one processor, individually or collectively, may cause the wireless network device to control the at least one border router to generate one or more route information options (RIOs) including the context information; control the at least one border router to include the one or more route information options in an IPv6 router advertisement packet; and control the at least one border router to send the IPv6 router advertisement packet to the network node.

The instructions, when executed by the at least one processor, individually or collectively, may cause the wireless network device to control the thread node to obtain route path counts from a plurality of border routers based on the on-mesh prefix; control the thread node to assign a border router, from among the plurality of border routers, having a shortest route path to the thread node as a primary border router; control the thread node to assign another border router, from among the plurality of border routers, as a backup border router; control the thread node to send an uplink packet through the primary border router based on the primary border router being available; and control the thread node to send an uplink packet through the backup border router based on the primary border router being unavailable.

The instructions, when executed by the at least one processor, individually or collectively, may cause the wireless network device to control the at least one border router to assign a primary on-mesh prefix to the thread node for communication through the primary border router; control the at least one border router to assign a backup on-mesh prefix to the thread node for communication through the backup border router; control the thread node to use the primary on-mesh prefix to send an uplink packet through the primary border router based on the primary border router being available; and control the thread node to use the backup on-mesh prefix to send an uplink packet through the backup border router based on the primary border router being unavailable.

The instructions, when executed by the at least one processor, individually or collectively, may cause the wireless network device to control the at least one border router to assign a primary sub-prefix to the thread node for communication through the primary border router; control the at least one border router to assign a backup sub-prefix to the thread node for communication through the backup border router; control the thread node to use the primary sub-prefix to send an uplink packet through the primary border router based on the primary border router being available; and control the thread node to use the backup sub-prefix to send an uplink packet through the backup border router based on the primary border router being unavailable.

The instructions, when executed by the at least one processor, individually or collectively, may cause the wireless network device to control the at least one border router to calculate a first route path count for the thread node based on a hop count from the at least one border router to the thread node; control the at least one border router to calculate a second route path count for the thread node based on a round-trip time from the at least one border router to the thread node; and control the at least one border router to determine the shortest route path from the at least one border router to the thread node based on at least one of the first route path count and the second route path count.

According to an aspect of the disclosure, a method for routing downlink data packets in a thread network includes determining, by at least one border router, a shortest route path from the at least one border router to a thread node in a thread network; assigning, by the at least one border router, a preferred border router to the thread node based on the determined shortest route path; sending, by the at least one border router, context information in an advertisement packet to a network node, wherein the context information indicates the assigned preferred border router for the thread node; and sending, by the network node, at least one downlink packet to the thread node through the assigned preferred border router.

The determining the shortest route path may include assigning, by the at least one border router, an on-mesh prefix to the thread node; sending, by the at least one border router, the on-mesh prefix to the thread node; obtaining, by the thread node, a route path count from the at least one border router based on the on-mesh prefix; sending, by the thread node, information identifying the preferred border router to the at least one border router; and determining, by the at least one border router, the shortest route path from the at least one border router to the thread node based on the obtained route path count.

The determining the shortest route path may include generating, by the at least one border router, a sub-prefix by sub-netting the thread network; sending, by the at least one border router, the sub-prefix to the thread node; obtaining, by the thread node, a route path count from the at least one border router based on the sub-prefix; sending, by the thread node, information identifying the preferred border router to the at least one border router; and determining, by the at least one border router, the shortest route path from the at least one border router to the thread node based on the obtained route path count.

The determining the shortest route path may include receiving, by at least one first border router, a routing table and a child table from at least one second border router; obtaining, by the at least one first border router, a route path count for the thread node from the routing table and the child table; and determining, by the at least one first border router, a shortest route path from the at least one first border router to the thread node based on the obtained route path count.

The routing table may be populated with information identifying the thread node and a preferred border router for the thread node that is selected from among the at least one first border router and the at least one second border router.

The sending the context information may include generating, by the at least one border router, one or more route information options including the context information; including, by the at least one border router, the one or more route information options (ROIs) in an IPv6 router advertisement packet; and sending by the at least one border router, the IPv6 router advertisement packet to the network node.

The determining the shortest route path may include obtaining, by the thread node, route path counts from a plurality of border routers based on the on-mesh prefix; the assigning the preferred border router may include assigning, by the thread node, a border router, from among the plurality of border routers, having a shortest route path to the thread node as a primary border router; and assigning, by the thread node, another border router, from among the plurality of border routers, as a backup border router, and the method may further include sending, by the thread node, an uplink packet through the primary border router based on the primary border router being available; and sending, by the thread node, an uplink packet through the backup border router based on the primary border router being unavailable.

The assigning the on-mesh prefix may include assigning, by the at least one border router, a primary on-mesh prefix to the thread node for communication through the primary border router; and assigning, by the at least one border router, a backup on-mesh prefix to the thread node for communication through the backup border router; and the method may further include using, by the thread node, the primary on-mesh prefix to send an uplink packet through the primary border router based on the primary border router being available; and using, by the thread node, the backup on-mesh prefix to send an uplink packet through the backup border router based on the primary border router being unavailable.

The assigning the on-mesh prefix may include assigning, by the at least one border router, a primary sub-prefix to the thread node for communication through the primary border router; and assigning, by the at least one border router, a backup sub-prefix to the thread node for communication through the backup border router, and the method may further include using, by the thread node, the primary sub-prefix to send an uplink packet through the primary border router based on the primary border router being available; and using, by the thread node, the backup sub-prefix to send an uplink packet through the backup border router based on the primary border router being unavailable.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following illustrated drawings. Embodiments herein are illustrated by way of examples in the accompanying drawings, and in which:

FIG. 1A depicts example scenario, of one or more nodes in a thread network, according to existing arts;

FIG. 1B depicts an example scenario, for routing the thread node downlink traffic in IoT networks, according to existing arts;

FIG. 1C depicts an example scenario, for routing the thread node downlink traffic in IoT networks, according to existing arts;

FIG. 2 depicts a block diagram of the wireless network device in the IoT environment, according to embodiments as disclosed herein;

FIG. 3A shows an example flowchart of the process for selecting a preferred border router for each T of all thread nodes, according to embodiments as disclosed herein;

FIG. 3B depicts an example scenario, wherein a preferred border router is selected for each T of all thread nodes, according to embodiments as disclosed herein;

FIG. 4 depicts an example scenario, wherein multiple on-mesh prefixes are used for the thread nodes, according to embodiments as disclosed herein;

FIGS. 5A and 5B depict an exemplary scenario, wherein a sub-netting technique is applied to distribute a single on mesh prefix to the one or more border routers, according to embodiments as disclosed herein;

FIG. 6A depicts an example use case, wherein the downlink traffic packet is routed in the thread network, according to embodiments as disclosed herein;

FIG. 6B shows a graph of an example evaluation of the traffic routing issue in the thread node, according to embodiments as disclosed herein;

FIG. 7 depicts an example use case, wherein the downlink traffic packet is routed in the thread network, according to embodiments as disclosed herein;

FIG. 8A shows a method for routing the downlink traffic data in the IoT environment, according to embodiments as disclosed herein;

FIG. 8B shows a method for routing the downlink traffic data in the IoT environment, according to embodiments as disclosed herein;

FIG. 8C shows a method for routing the downlink traffic data in the IoT environment, according to embodiments as disclosed herein;

FIG. 9 depicts a method for downlink routing management in a thread network in an Internet of Things (IoT) environment, according to embodiments as disclosed herein; and

FIG. 10 depicts a method for downlink routing management in a thread network in an Internet of Things (IoT) environment, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed Is sequential ordering/placement/occurrence unless specified otherwise.

Embodiments herein disclose methods and systems for identifying and resolving thread network downlink non-optimal path issue(s), when more than one border router (BR) connected with the same backhaul is used. The identifying of a thread node includes but not limited to, extracting thread tag length values (TLVs) from network data, understanding the presence of more than one border routers.

Embodiments herein share the internal contextual information of the thread networks (i.e., internal contextual information of all thread nodes) to the backhaul Wi-Fi Network to enable a Wi-Fi Router to take the best routing decision for downlink traffic of thread nodes. With this information, the downlink (DL) traffic belonging to any of the thread nodes may always be sent via a shortest route path from the home Wi-Fi router.

Embodiments herein, disclose methods and systems to share the contextual information of the thread nodes. The method includes providing each thread device route to the uplink Wi-Fi Router. Either the primary border router (PBR) or one of the secondary border routers (SBR) retrieves a routing table and a child table from all other border routers and calculates the route path count from each of the border routers to every thread node ‘T’. Out of many border routers (BRs), the border router with the shortest route path count to the thread node ‘T’ may be marked as a preferred border router of that thread node. Similarly, the preferred border router information is calculated for all the thread nodes.

In an embodiment herein, the selected preferred border router information of all the thread nodes is advertised over the backhaul Wi-Fi link by one or more border routers using IPv6 router advertisement packets and route information options (RIOs). One or more border routers generate one or more route information options comprising the context information, include the route information options in an IPv6 router advertisement packet, and send the IPv6 router advertisement packet to the network node. The network node, upon receiving the RIO advertisement, adds the border router into its routing table and refers to the routing table when it needs to forward downlink traffic to thread node(s).

Embodiments herein disclose a border router on-mesh prefix solution for each border router. Each border router creates its own unique on-mesh prefix. Each of these prefixes belonging to multiple border routers are advertised to all the nodes in the thread network. Each thread node obtains, from a plurality of border routers, route path counts based on the on-mesh prefix, and applies the on-mesh prefix on thread interfaces of the thread node. Each thread node calculates the shortest route path count for the on-mesh prefix of the border router, wherein the border router with the shortest route path count is considered as the primary border router and the primary border router is used for uplink communication. Each border router with its own unique prefix will advertise the on-mesh prefix with higher precedence over the Wi-Fi backhaul link. Additionally, each border router advertises prefixes of other border routers with lower precedence in order to have them as alternate paths. In an embodiment herein, the thread network may keep other on-mesh prefixes as backup and use the backup when the primary border router is unavailable (e.g., the primary border router link is broken or non-responsive).

Embodiments herein disclose an on-mesh prefix sub-netting solution. Embodiments herein may subnet a single on-mesh prefix into multiple sub-prefixes based on the number of border routers present in the thread network. Each border router will own one such on-mesh sub-prefix, and each of these sub-prefixes belonging to multiple border routers are advertised to all the nodes in the thread network. On receiving such on-mesh sub-prefix from each border router, each thread node applies the on-mesh sub-prefix on thread interfaces. Each thread node obtains a route path count from at least one border router based on the sub-prefix, and considers the sub-prefix having the shortest route path count as a primary on-mesh sub-prefix link and uses the primary on-mesh sub-prefix link for on-mesh sub-prefix uplink communication. Each border router owning a specific sub-prefix will advertise it with higher precedence over the Wi-Fi backhaul link. Additionally, each border router advertises other border routers' sub-prefixes with lower precedence in order to have them as alternate paths. Embodiments herein keep other on-mesh sub-prefixes as a backup for use when the primary on-mesh sub-prefix is unavailable (e.g., the primary on-mesh sub-prefix is broken or non-responsive).

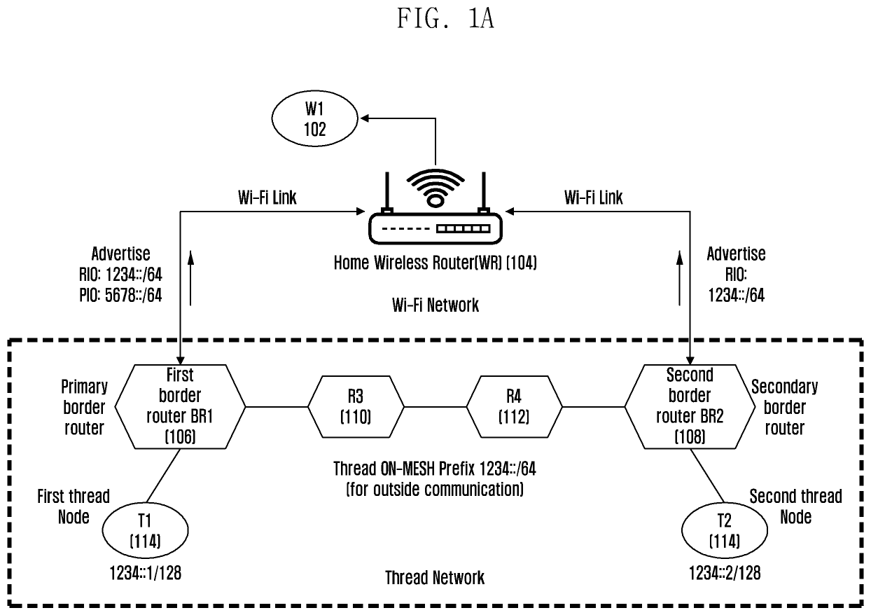

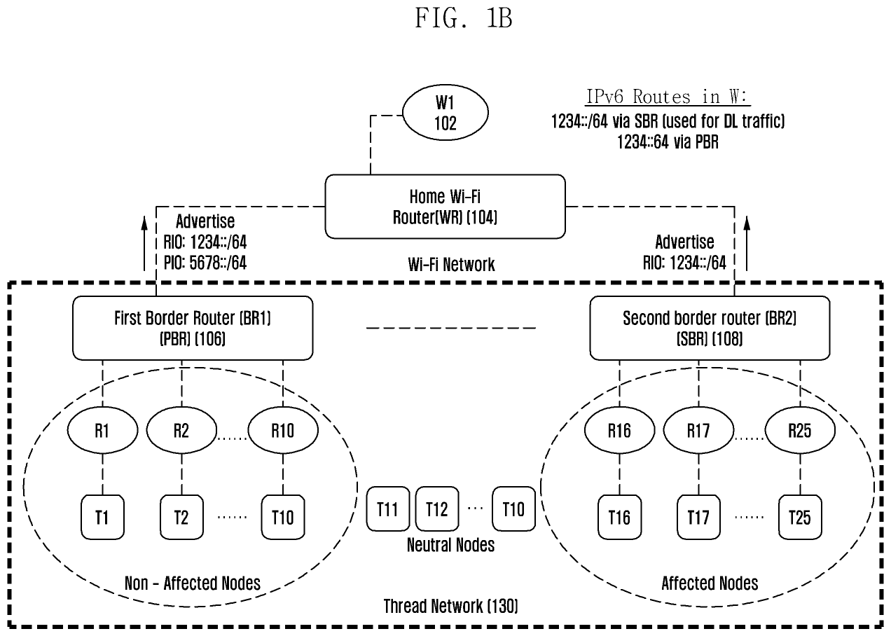

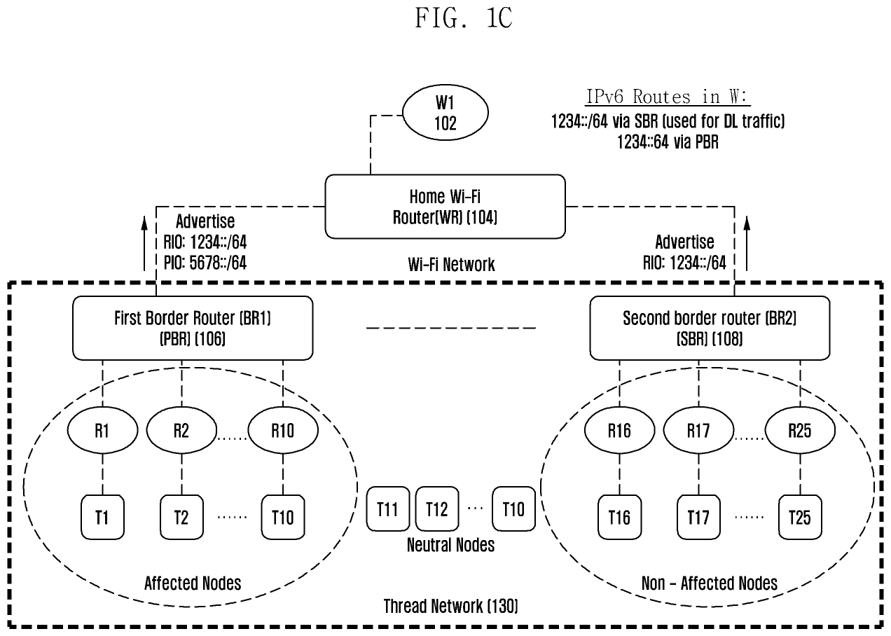

FIG. 1A depicts an example scenario, wherein the thread downlink performance in IoT networks is affected. The Thread Network downlink (DL) performance issue occurs when a minimum of 2 BRs (106) and (108) are connected with the same backhaul Wi-Fi Link. As shown in FIG. 1A, the network comprises at least two preferred border routers (a first border router BR1 (106), and a second border router BR2 (108)). Further the network may comprise two intermediate routers (namely R3 and R4) as part of the thread network for Wi-Fi nodes to reach the thread nodes, and two thread end nodes (a first end node T1 and a second end node T2). Further the network comprises one Wi-Fi node (W1) and one home wireless router (WR) in backhaul Wi-Fi Network. The first border router BR1 (106) and the second border router BR2 (108) being primary and secondary border routers of the thread network are equally responsible to advertise the same thread on-mesh network prefix address, for example 1234::/64. The given network prefix address represents all nodes of the thread network over the backhaul Wi-Fi link using route information option (RIO) of an IPv6 router advertisement packet. The network prefix address indicates to the backhaul Wi-Fi nodes that the first border router BR1 (106) and the second border router BR2 (108) are two contact points also known as gateways through which the Wi-Fi router may reach any of the thread nodes in the thread network. The home wireless router (WR) (104) and Wi-Fi node (W1) (102) add both the routes of BR1 (106) and BR2 (108) in their respective routing tables and refer to the routing table while forwarding downlink traffic to any of the thread nodes. The table maintained by home wireless router (WR) (104) or the Wi-Fi node (102) (W1) has two routes, i.e., one via BR1 (106) and other via BR2 (108). However, while sending downlink traffic, the home wireless router (WR) (204) and Wi-Fi node (W1) (202) uses the first entry, that is on the top of the routing table of the border router to route the packet, i.e. the border router (BR) that advertised first will be the first entry (or top) in routing table. In example scenario as shown in FIG. 1A, the first border router (BR1) (106) is in the first place (or top) for case 1 and the second border router (BR2) (108) is in first place (or top) for case 2. Based on the first or the top routing entry in the routing table, the Wi-Fi node (W1) selects either the first border router (BR1) (106) or the second border router (BR2) (108) as a thread gateway to forward packets to thread nodes.

For example, in a first case (case 1), the Wi-Fi node selects the second thread node (T2) to send a downlink packet. The first (or top) route entry is the first border router (BR1) (106) preferred border router in Wi-Fi node (W1). Now, to send downlink (DL) traffic to T2 the path chosen is W1->WR->BR1->R3->R4->BR2->T2. However, W1->WR->BR2->T2 is the shortest route path for sending the downlink traffic packet. Choosing the first route entry from the routing table, without considering the shortest route path results in significant delay of routing the downlink traffic packet. Thus, in the first case, even though there exists the shortest route path from W1 to T2 via BR2 (108), the Wi-Fi node takes the non-optimal path via BR1 due to unavailability of internal thread topology information at the Wi-Fi node side.

For example in second case (case 2), the Wi-Fi node selects the first thread node to send a downlink packet to the second thread node (T2). The first (or top) route entry is second border router (BR2) (108) in the Wi-Fi node (W1), then to send downlink (DL) traffic to the thread node (T1), the path chosen is W1->WR->BR2->R4->R3->BR1->T1. However, W1->WR->BR1->T1 is the shortest route path. Choosing the first route entry from the routing table, without considering the shortest route path results in significant delay of routing the packet. Similarly, in the second case, even though there exists a preferred path from W1 to T1 via BR1 (106), it takes a non-optimal path via BR2 (108) due to unavailability of internal thread topology information at a Wi-Fi side. This results in downlink traffic of 50% of the Thread nodes taking the non-optimal path.

As depicted in FIG. 1B, the first route entry in the Wi-Fi node (W1) is: 1234::/64 via a primary border router (PBR) (106). Consider that there are twenty five thread end nodes in the given thread network, wherein the first 10 nodes i.e., T1, T2, T3 . . . T10 are near to the primary border router (PBR) (106) than a secondary border router (SBR) (108), and the last 10 nodes (T16, T17 . . . T25) are near to the SBR (106) than the PBR (108), and the middle 5 nodes (T11, T12 . . . T15) are equidistant from both the PBR (106) and the SBR (108). For the Wi-Fi node (W1), out of the 25 thread end nodes, there is no problem for the first 10 nodes, as the first 10 nodes (T1, T2, T3 . . . T10) may be reached through the PBR (106) faster as the thread node's internal route path count is the shortest from the PBR (106) preferred border router to each of the first ten thread end nodes. However, to reach the last ten thread end nodes (T16, T17 . . . T25) through the same PBR (106) as the preferred border router, it takes more time as the thread node's internal route path count is the longest from the PBR (106) as the preferred border router to each of the last ten thread nodes (T16, T17. T25). The middle five thread end nodes (T11, T12, T13, T14, T15) are almost equidistant from both the PBR (106) and the SBR. Therefore the middle five thread end nodes (T11, T12, T13, T14, T15) does not have much impact, if the downlink (DL) traffic is routed either through the PBR (106) or the SBR (108).

When an internet service provider (ISP) gives a global IPv6 prefix to the Wi-Fi network, the Wi-Fi node in turn hands over a subset of that prefix to PBR (106) using prefix delegation to assign global IPv6 addresses to all the thread nodes. When the cloud sends a command to thread node ‘T’ using its global IPv6 address, the downlink traffic issue occurs based on the routing entries of the PBR (106) and the SBR (108) as the preferred border routers in upstream Wi-Fi Access Point Router.

As depicted in FIG. 1C, consider that the top most routing entry in Wi-Fi node or in the Wi-Fi Router is: 1234::/64 via SBR (108), where the SBR (108) is the preferred border router for the thread's downlink traffic; i.e., the thread's downlink traffic will be routed through the SBR (108). There are 25 thread end nodes in the thread network. The first ten nodes (T1, T2, T3 . . . T10) are closer to the PBR (106) than the SBR (108). The last 10 nodes (T16, T17 . . . T25) are closer to the SBR (108) than the PBR (106), and the middle 5 nodes (11, 12 . . . 15) are equidistant from both the PBR (106) and the SBR (108). The downlink traffic through the second border router as the preferred border router to reach the first 10 nodes (T1, T2, T3 . . . T10) it takes more time as the thread's internal route path count is more from the SBR (108) preferred border router to the first ten thread end nodes. The last ten thread nodes (T16, T17 . . . T25) may be reached through the SBR (108) faster as the thread's internal route path count is shortest from the SBR (108) GW to the last ten thread nodes. The middle five thread nodes (T11, T12, T13, T14, T15) which are almost equidistant from both the PBR (106) and the SBR (108) will not have much impact if their downlink traffic is routed either through the PBR (106) or the SBR (108).

Hence, there is a need in the art for solutions which will overcome the above mentioned drawback(s), among others.

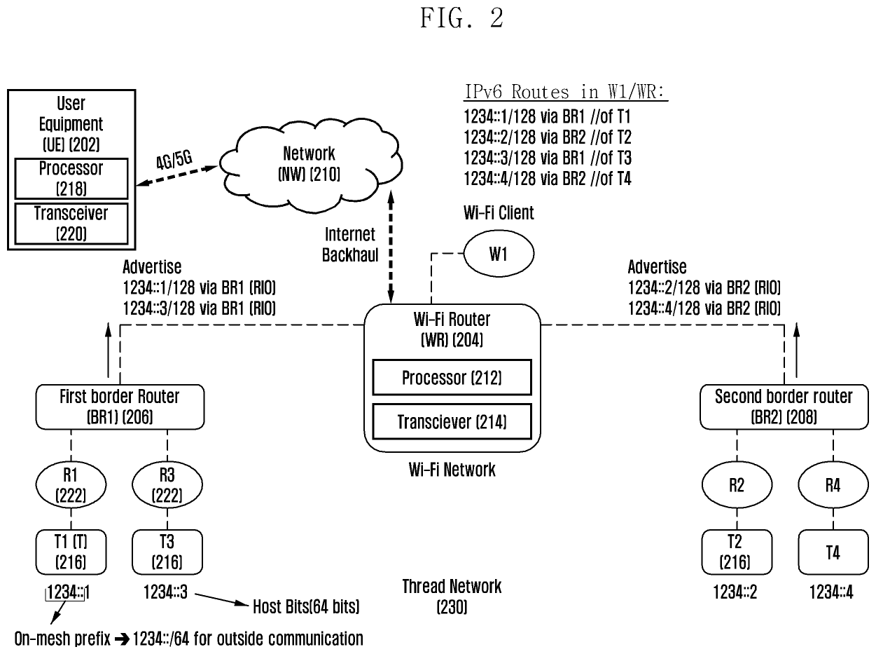

The embodiments herein achieve systems and methods for routing downlink data packets in a thread network. Referring now to the drawings, and more particularly to FIGS. 2 through 10, where similar reference characters denote corresponding features consistently throughout the figures, there are shown at least one embodiment.

FIG. 2 depicts a block diagram of the wireless network device in the IoT environment, according to embodiments as disclosed herein. FIG. 2 shows a wireless communication environment, comprising a wireless network device (WR) (204), a user equipment to communicate (UE) (202) with the wireless communication environment, a border router (BR) (206) (208), a thread node (T) (216) and a network (NW) (210). The thread nodes (T) (216) are the end devices that are controlled by the wireless communication device (WR) (204) through the user equipment (UE) (202). In an embodiment herein, the wireless communication device is a Wi-Fi Router (also referred to herein as a home router). In an embodiment herein, the wireless communication environment is an Internet of Things (IoT) environment.

The wireless network device (204) comprises a transceiver (214); and a processor (212) configured to communicate in an Internet of Things (IoT) environment through the transceiver (214). The processor (212) may include various processing circuitry and/or multiple processor. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor (212) controls at least one border router (206) (208) to determine a shortest route path from the border router to the thread node (T) (216) in the thread network (230). The shortest route path may be determined based on the round-trip time of a packet to reach the thread node through that particular border router. The processor (212) assigns the on-mesh prefix to the thread node (T) through the border router (206) (208). The on-mesh prefix is sent to the thread node (T) through that particular border router (206) (208). The thread node (T) obtains and sends to the processor a route path count of the border router (206) (208) based on the on-mesh prefix. The processor (212) controls the border router to determine the shortest route path from the border router to the thread node based on the obtained route path count and to advertise a preferred border router to all border routers from the determined shortest route path for each thread node from the obtained route path count. For e.g., the on-mesh prefix of T1 is 1234::1 and the on mesh prefix of T2 is 1234::2. The determined route path count of T1 from BR1 is 1 and for T2 is 2. However, the shortest route path to T2 is determined to be from BR2, as the route path count from BR2 to T2 is 1. Therefore the BR2 is advertised as the preferred border router for the thread node T2. Therefore, the downlink traffic from WR to T2 may be sent through the BR2 as BR2 is the preferred border router for T2.

In an embodiment herein, the border router generates a sub-prefix by sub-netting the thread network (230). The sub-prefix is sent to each of the thread nodes (T1) to (T4). The thread nodes (T1) to (T4) are identified by the respective sub-prefixes. Based on the sub-prefix, each thread node obtains a route path count from at least one border router and sends the obtained route path count to the processor (212). Each thread node also sends the preferred border router to at least one border router. The preferred border router is then sent to the other border routers in the network. The processor (212) controls the border router (206) (208) to determine the shortest route path from the border router to the thread node (T) based on the obtained route path count in the thread network (230).

In an embodiment herein, the processor (212) determines, by the border router, the preferred border router (206) (208) to the thread node (T1) to (T4) based on the shortest route path. The processor (212) sends context information in an advertisement packet to a network node (NW) (210) through the border router (206) (208), wherein the context information indicates the assigned preferred border router for the thread node. A network node (NW) (210) communicates between the wireless network device (204) and the user equipment (202). The network node (210) sends at least one downlink packet from the user equipment (202) to thread node (216) through the assigned preferred border router (206) (208).

In an embodiment herein, the wireless network device (204) receives a routing table and a child table from one or more border routers (206) (208) through the processor (212). At least one first border router receives the routing table and the child table from at least one second border router. The routing table is populated for all the thread nodes (T) (216) with respective preferred border routers. The processor (212) controls the first border router to obtain a route path count for the thread node from the routing table and the child table and to determine a shortest route path from the first border router to the thread node based on the obtained route path count.

In an embodiment herein, the processor (212) determines the shortest route path for each thread node (T1) to (T4) in a thread network (230). The processor (212) sends the shortest route path in an advertisement packet to the network node (210). The shortest route path is a shortest transmission path to one or more thread nodes (T1) to (T4).

In an embodiment herein, the user equipment (UE) (202) comprises a transceiver (220); and a processor (218) configured to communicate in an Internet of Things (IoT) environment through the transceiver (220). The processor (218) receives by a network node (210), the shortest route path included in the advertisement packet from one or more border routers (206) (208). The shortest route path comprises the preferred border router in a shortest transmission path to one or more thread nodes (T1) to (T4). The processor (218) sends a set of control instructions through the network node (210), to the preferred border router for operating the thread nodes (T1) to (T4).

In an embodiment herein, the border router (206) and (208) generates the on-mesh prefix and the on-mesh prefix is sent to all of the thread nodes (T1) to (T4) of the thread network (230). The thread nodes (T1) to (T4) derive and assign the on-mesh sub-prefix based IPv6 address to their thread interface. The border router (206) and (208) computes the shortest route path to each of the thread node (T1) to (T4). The wireless network device (204) further decides the preferred border router for downlink (DL) traffic of each router including both joiner/intermediate router and the border router, which is part of the thread network (230). In an embodiment herein, each router including both joiner/intermediate router (R) and the border router (206) and (208) have their own routing table and child table to reach out to other nodes in the thread network (230). Example of a routing table is shown in Table 1.

TABLE 1

| | On mesh | Route | Route | Preferred |
|---|---|---|---|---|
| Thread | prefix based on | path count | path count | border router for |
| Nodes | IPv6 Address | from BR1 | from BR1 | Wi-Fi Router |
| T1 | 1234::1 | 2 | 3 | BR1 |
| T2 | 1234::2 | 3 | 2 | BR2 |
| T3 | 1234::3 | 2 | 3 | BR1 |
| T4 | 1234::4 | 3 | 2 | BR2 |

For example, the thread network (230) comprises a first border router (BR1) (206) and a second border router (BR2) (208) connected to the wireless network device (204) to enable the Wi-Fi Nodes to reach thread nodes (T1 to T4). The thread network (230) further comprises four intermediate routers; i.e., a first intermediate router (R1), a second intermediate router (R2), a third intermediate router (R3), and a fourth intermediate router (R4). The thread network (230) further comprises four thread end nodes; i.e., a first thread node (T1), a second thread node (T2), a third thread node (T3), and fourth thread node (T4) (connected as shown in FIG. 2). Further, the thread network (230) comprises the Wi-Fi node (W1) and a wireless communication device (WR) (204) in the backhaul Wi-Fi Network. WR connects both Wi-Fi nodes and thread nodes (T1) to (T4) to the internet. The user equipment (202) is used to send remote control commands for Thread IoT nodes via the Internet. The user equipment may comprise but not limited to a mobile device, a handheld device, a palmtop, a desktop, a computer device, and a kiosk or any other device capable of being in an IOT environment.

In an embodiment herein, the preferred border router is determined corresponding to downlink traffic of each of the thread nodes, based on the shortest route path count of each of the border router (206) and (208) with the thread nodes (T1) to (T4). The processor (212) advertises the preferred border router information using Route Information Option (RIO) of an IPv6 Router Advertisement packet over a backhaul Wi-Fi Network. In an embodiment herein, determining the preferred border router ensures downlink traffic belonging to any of the thread nodes will always be sent through the shortest route path.

In an embodiment herein, the first border router (BR1) retrieves the router table and child tables from at least one second border router; for example, as shown in Table 1. The first border router (BR1) calculates the route path count (PC) from each of the border routers (206) and (208) to every thread node (T1) to (T4) based on the routing table and the child table, and determines a shortest route path from the first border router to the thread node based on the obtained route path count. From the number of border routers available in the thread network (230), the border router with the shortest route path count to the thread node T is selected as the preferred border router.

In an embodiment herein, the distributed routing table is populated with information identifying the thread node and a preferred border router for the thread node that is selected from among the at least one first border router and the at least one second border router. The preferred border router information of all the thread nodes (T1) to (T4) is advertised over the backhaul Wi-Fi link by the one or more border routers (206) and (208) using one or more route information options (RIOs) in single or multiple IPv6 router advertisement packets. Examples of IPv6 router advertisement packets are as below:
T1 Route->1234::1/128 via fe80::212:34ff: fe6b: a0a8 (link local address(lla) of ‘wlan0’ of first border router BR1) to one RIO
T2 Route->1234::2/128 via fe80::212:34ff: fe2f:704f (link local address(lla) of ‘wlan0’ of second border BR2) to another RIO

In an embodiment herein, context information in an advertisement packet of the thread nodes is sent to the backhaul Wi-Fi Network in the form of RIO. The context information in the advertisement packet of the thread node may include information indicating the preferred border router of each of the thread nodes. The context information in the advertisement packet enables the wireless network device to choose the appropriate preferred border router. The border router chosen has the shortest route path corresponding to the downlink traffic of each of the thread nodes. Using this information, the downlink traffic belonging to any of the thread nodes will always be sent through the preferred border router.

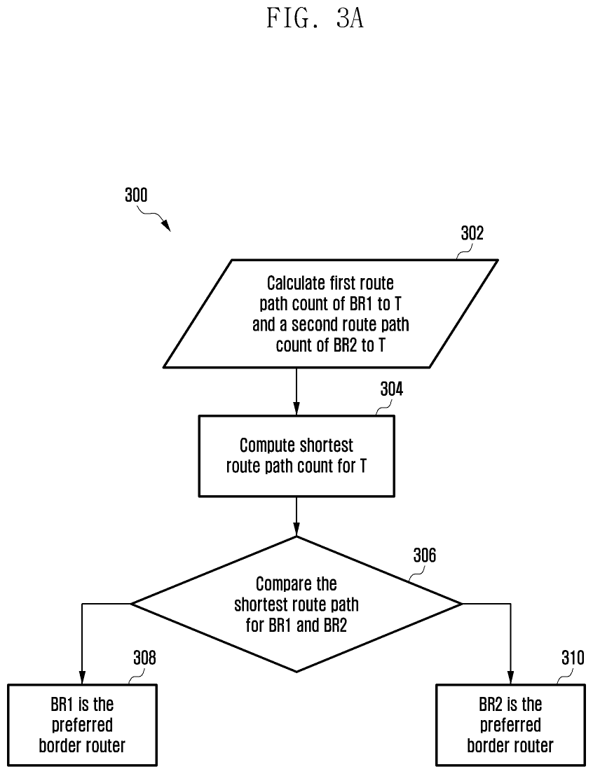

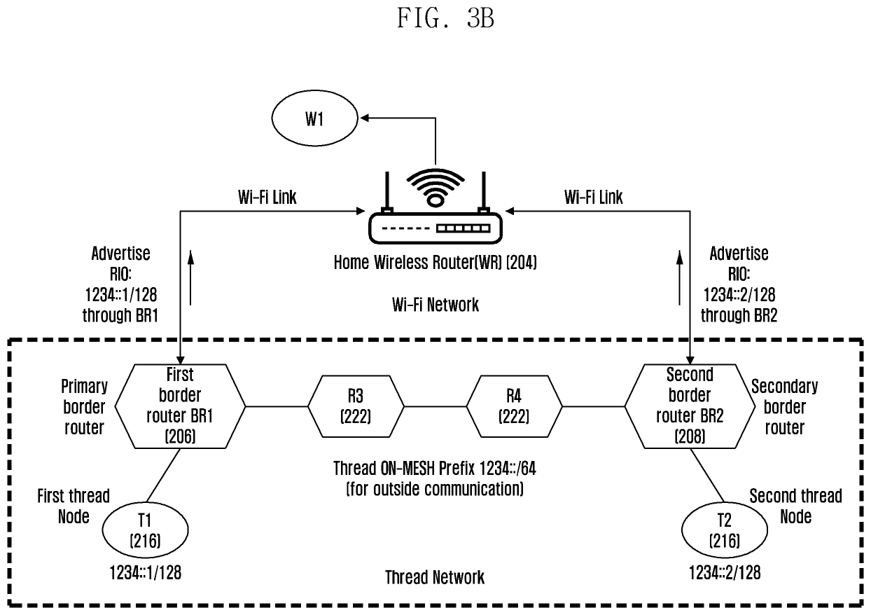

FIG. 3A shows an example flowchart of the process for selecting a preferred border router for each T of all thread nodes, according to embodiments as disclosed herein. For example, a thread node T is connected to the wireless communication device through a first border router (206) and also through a second border router (208). At step 302, the processor (212) of the wireless communication device calculates a first route path count of the thread node T1 from the first border router (206) based on a hop count, and a second route path count from the second border router (208) based on a round-trip time. The processor (212) calculates the hop count the first border router (206) and the second border router (208) need to take to reach the thread node T1. At step 304, the processor (212) compares the first route path count of the first border router (206) and the second route path count from the second border router (208) and determines the shortest route path to the thread node T1. At step 306, the shortest route path to the thread node T1 is from the first border router (206), then at step 308 the first border router (206) is selected as the preferred border router, else if the shortest route path is determined from the second border router (208), then at step 310, the second border router (208) is selected as the preferred border router. The various actions in method 300 may be performed in the order presented, in a different order or simultaneously.

FIG. 3B depicts an example scenario, wherein a preferred border router is selected for each T of all thread nodes, according to embodiments as disclosed herein. In this example, the route path count from the first border router (206) to T1 and the second border router (208) to thread node T1 is calculated as follows:
If (route path count (BR1->T1)<=Route path count (BR2->T1))
‘preferred border router for ‘T1’ is BR1;
else
‘preferred border router for ‘T1’ is BR2.

Based on the above calculation, either ‘BR1’ or ‘BR2’ can be selected as the preferred border router for each of the thread nodes. The context information of the preferred border router of each of the thread nodes will be shared with the Wi-Fi Network. Using this information, the downlink traffic belonging to any of the thread nodes will always be sent through the preferred border router.

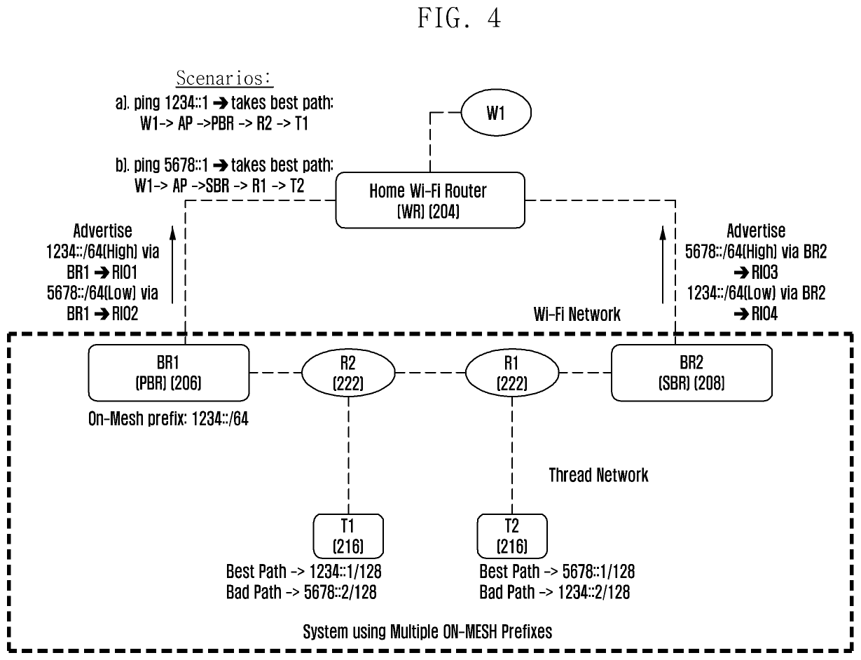

FIG. 4 depicts an example scenario, wherein multiple on-mesh prefixes are used for the thread nodes, according to embodiments as disclosed herein. As depicted in FIG. 4, embodiments herein use two on-mesh prefixes a first on-mesh prefix (prf1) from the first border router and a second on-mesh prefix (prf2) from the second border router to operate with two border routers; i.e., the PBR (206) and the SBR (208).

The PBR (206) advertises the first on-mesh prefix (prf1) based on a first RIO with a high priority and the SBR (208) advertises the same first on-mesh prefix (prf1) based on a first RIO with a low or medium priority, based on the shortest route path count from the border router to the thread node. In an embodiment herein, the PBR (206) generates two such on-mesh prefixes. In an embodiment herein, the PBR (206) generates the first on-mesh-prefix (prf1) and the SBR (208) generates a second on-mesh prefix (prf2). Each thread node may have two addresses; a first address based on the first on-mesh prefix (prf1) and a second address based on the second on-mesh prefix (prf2). For e.g., the thread node T1 has the first on-mesh prefix (prf1) as 1234::1/128 and the second on-mesh prefix (prf2) as 5678::2/128. The thread nodes that are determined to have a shortest route path count to the PBR (206) as compared to the SBR (208), use the first address from prf1 as their primary address and use the second address from second on-mesh prefix (prf2) as the secondary address for backup. The thread nodes that are determined to have the short route path count to the SBR (208) compared to the PBR (206), use the second address from the second on-mesh prefix (prf2) as their primary address and the first address from the first on-mesh prefix (prf1) as the secondary address for backup. In an embodiment herein, the border routers send the information of the primary and secondary addresses over the backhaul Wi-Fi link using RIO as the context information in the advertisement packet. The PBR (206) advertises the first on-mesh prefix with the first RIO with high priority and the SBR (208) advertises the same on-mesh prefix with medium or low priority as a backup path to be used, when the PBR (206) is unavailable or the PBR (206)'s Wi-Fi link has issues such as low throughput or congestion, for example.

In an embodiment herein, the SBR (208) advertises the second on-mesh prefix (prf2) based on the second route information option with high priority and the PBR (206) advertises the same second on-mesh prefix based on the second route information option with medium or low priority, as a backup path to reach out when the SBR (208) is unavailable or the SBR (208)'s Wi-Fi link has issues.

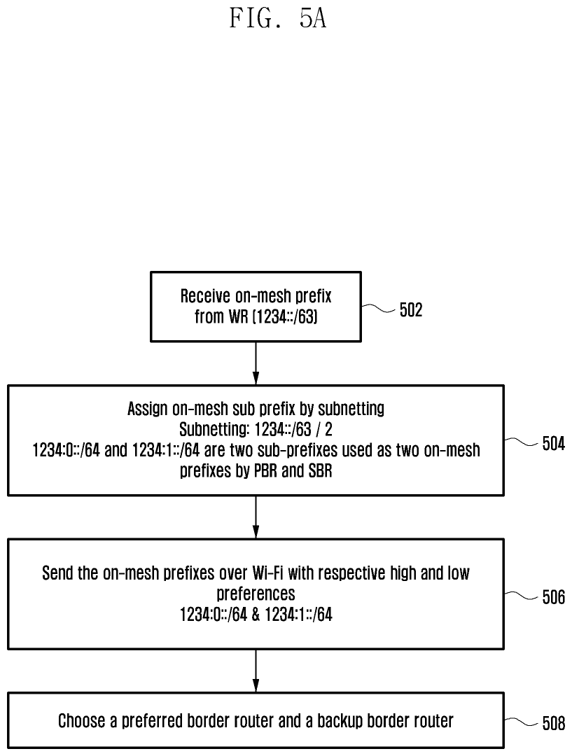

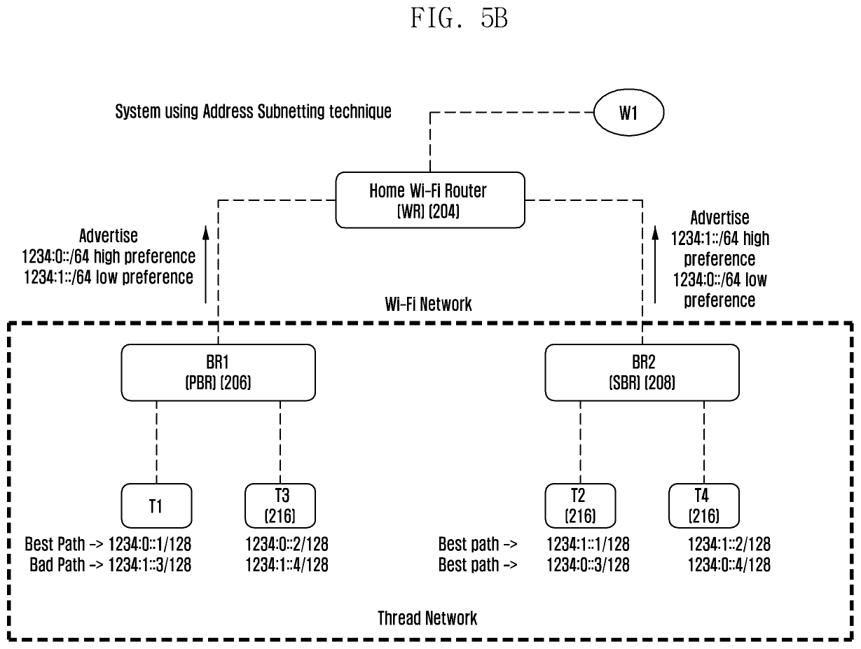

FIGS. 5A and 5B depict an exemplary scenario, wherein a sub-netting technique is applied to distribute a single on mesh prefix to the one or more border routers, according to embodiments as disclosed herein. There are two preferred border routers, the first border router (BR1) (206) and the second border router (BR2) (208) for the wireless communication network to reach to thread nodes. There are four thread end nodes (i.e., T1, T2, T3, and T4) connected to both the border routers, as shown in FIG. 5B. At step 502, the first border router (206) generates a single on-mesh prefix for e.g., 1234::/64 for the primary border router (206). At step 504, the border router further generates a sub-prefix for each thread node. For example, for the first border router (206), the sub-prefix is generated as 1234::0/64 and for the second border router (208), the sub-prefix is generated as 1234::1/64. At step 506, the border router sends the on-mesh prefixes over Wi-Fi with respective high and low preferences. The Wi-Fi router (W1) chooses a preferred border router based on the shortest route path identified by the border router. And the Wi-Fi router keeps the other nearby border router as a backup. As shown in FIG. 5B, the Wi-Fi router (W1) uses the first route entry according to the shortest route path, while sending downlink traffic from W1 to T1, and T3 with address 1234::0/64 through the PBR (206). The downlink traffic of T1, T3 will always take the first border router as the preferred path. The Wi-Fi router (W1) uses its 2nd route entry for sending downlink traffic from W1 to T2, T4 that is it uses 1234::1/64 through the SBR (208) to send the downlink traffic to T3 and T4. The downlink traffic of T2, T4 will always take the preferred path through the SBR (208) as the sub-prefix 1234::1/64 has the shortest route path count to T3 and T4.

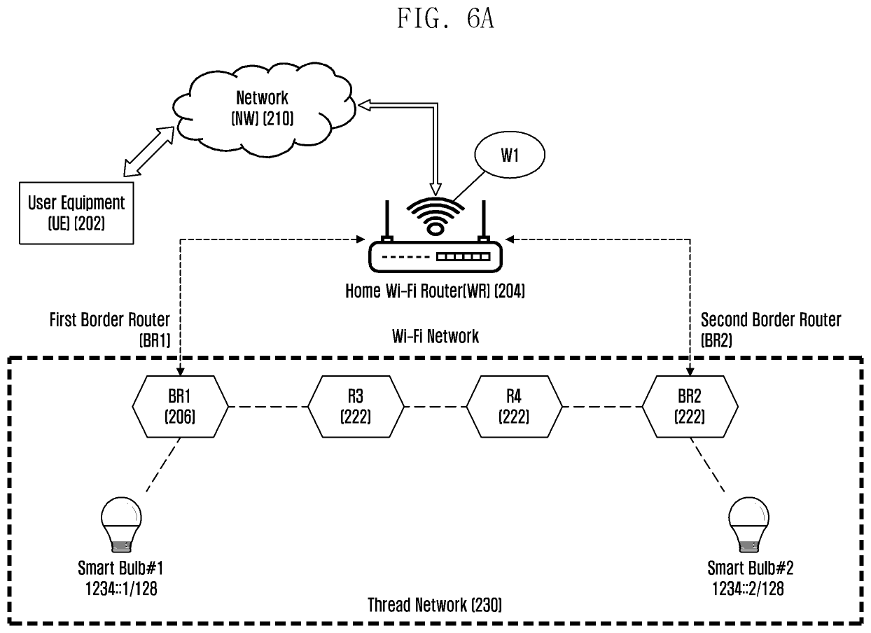

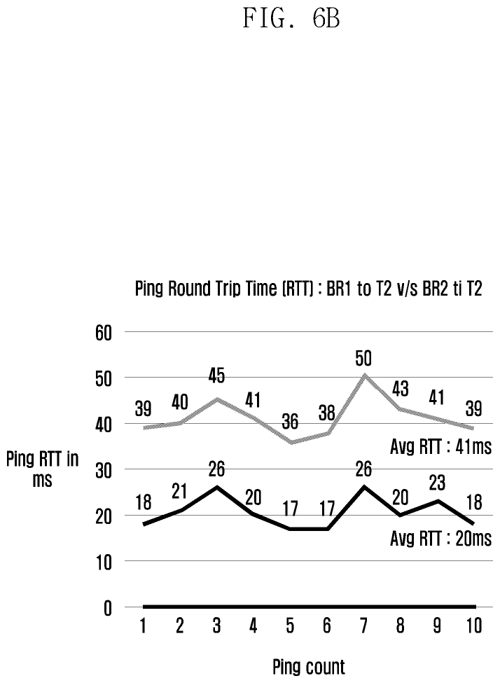

FIG. 6A depict an example use case, wherein the downlink traffic packet is routed in the thread network (230), according to embodiments as disclosed herein. The example shows an operation of a switch to turn ON/OFF operation of a Nano leaf bulb in an IoT environment through the user device. Embodiments herein provide a significant improvement in downlink performance of turning ON and OFF operation of the Nano leaf bulb in the IoT environment through the user device.

In an embodiment disclosed herein, the user equipment sends a control command to turn the switch (ON/OFF) to thread node (named ‘Nano leaf bulb #1’) using the address as 128-bit IPv6 address 1234::2/128. The control command for the bulb #1 reaches the Wi-Fi router from the network through the internet. The first border router and the second border router send the same 64-bits thread network (230) prefix (for e.g., 1234::/64) that represents all the border routers in the thread network (230) over the backhaul Wi-Fi Link using the route information option (RIO) in an IPv6 Router Advertisement packet. The Wi-Fi link (WR) may add both of the routes through the first border router (BR1) (206) and the second border router (BR2) (208) in its respective routing tables to reach any of the thread nodes. The routes populated in the routing table can be according to the shortest route path count; i.e., the first entry of the routing table has the shortest route path from the border router to the bulb #2 thread node. There are two routes corresponding to 64-bits of on-mesh prefix in the WR now through the first border router and the second border router. The border router which is the first entry is used to forward downlink traffic to the thread node. In example case, consider that BR1 (206) is the first entry of the routing table, the downlink traffic packet is then routed through BR1 (206). Also, whenever the first border router (BR1) restarts or goes down, the downlink traffic packet is routed through the second border router (BR2).

In an embodiment herein, the border routers share context of each of the thread nodes of the thread network (230) to the Wi-Fi network, which helps the Wi-Fi router to take the best routing decision for the thread node's downlink traffic. Both border routers (i.e., BR1 and BR2) separately calculate the route path count with each of the thread nodes to the Bulb #1 and the Bulb #2. The route path count to the thread node (for example, bulb #2) from the first border router and the second border router is compared. Then the border router that has the shortest route path to the thread node is selected as the preferred border router. In the depicted scenario, Bulb #2 is 1 hop away from the second border router (BR2) (208) and 4 hops away from the first border router (BR1) (206). So, the second border router (BR2) (208) is selected as the preferred border router for the thread node ‘Bulb #2’ and the border router sends the context information to the Wi-Fi link (WR), i.e., the context to use the second border router (BR2) (208) as the preferred border router to forward downlink traffic to ‘Bulb #2. The context information is published in the backhaul Wi-Fi Network using RIO, so that the WR routes the downlink traffic to the Bulb #2 always through the preferred border router, thereby leading to a 50% performance improvement in sending the downlink traffic to the Bulb #2. In an embodiment herein, Bulb #1 is 1 hop away from the first border router (BR1) (206) and 4 hops away from the second border router (BR2) (208). So, the first border router (BR1) (206) is selected as the preferred border router for ‘Bulb #1’ and the context information to use the first border router (BR1) (206) as the preferred border router to reach ‘Bulb #1’ is published to the WR that routes Bulb #1's downlink traffic always via the preferred path through the first border router.

FIG. 6B shows a graph of an example evaluation of the traffic routing issue in the thread node. For an example herein, consider a control command to turn the bulb #2 is to be sent to the thread node ‘bulb #2’ for evaluating the downlink performance issue of Bulb #2. The route path count of the Bulb #2 ON command from the first border router (BR1) (206) and the second border router (BR2) to the Bulb #2 are considered. The first border router (BR1) (206) pings Bulb #2, to evaluate the route path count from the first border router to bulb #2. The route path from the first border router to T2 that is bulb #2 is BR1->R3->R4->BR2->T2), and the round trip time (RTT) is determined as 41 ms. The second border router (BR1) pings Bulb #2, to evaluate the route path count from the second border router to bulb #2. The route path from the second border router to T2 that is bulb #2 is BR2->T2), and the round trip time (RTT) is determined as 20 ms. FIG. 6B depicts the comparison of the results of the first border router and the second border router to T2. Thus, downlink performance of ON operation of the Bulb #2 is improved by ˜50%. This percentage is expected to improve further with a dense thread network (230) and with deploying more number of border routers with more number of entry points to reach to thread nodes from the user equipment in a thread network (230).

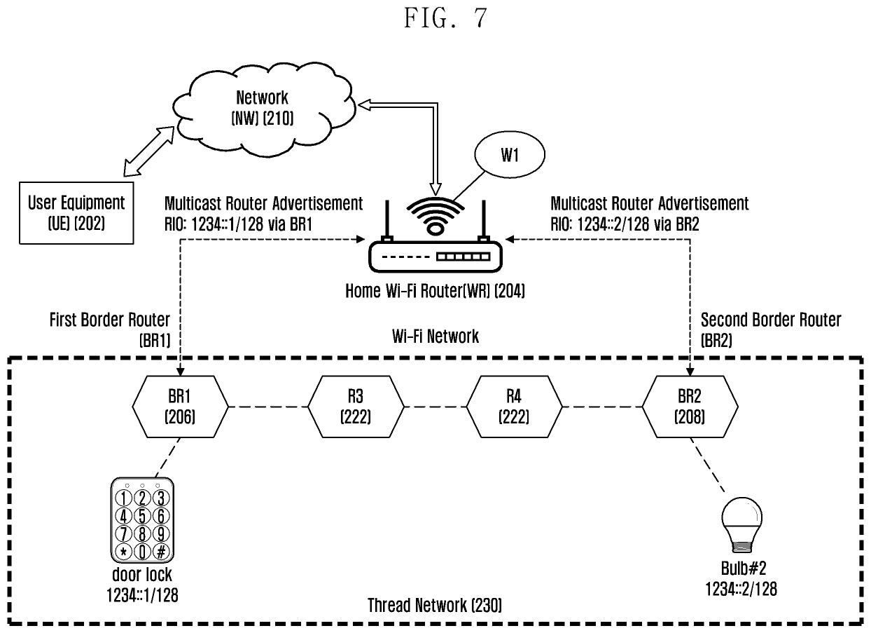

FIG. 7 depicts an example use case, wherein the downlink traffic packet is routed in the thread network (230), according to embodiments as disclosed herein. In an example scenario, that is based on a smart door lock and unlock operation. The routine in the user equipment (UE) for this scenario is configured, such that the application programming interface (API) triggers these commands remotely: The example thread network (230) comprises two Border Routers (206) (208) (BR1 and BR2), two thread routers (R3 and R4), one door lock and one bulb. The user configures routines to control the door and the bulb. When the door is unlocked, the bulb is switched ON in the living room automatically. When the door is locked, the bulb is switched OFF in the living room automatically. For controlling the operation of the bulb, the routing table of the Wi-Fi router (WR) contains separate routes for routing the downlink traffic of the door lock and the bulb. The route entry 1234::1/128 through BR1 (206) is applicable to the downlink traffic of door lock and the route entry 1234::2/128 through BR2 is applicable for downlink traffic of the bulb.

In an example use case scenario, to unlock the door, the UE may send the remote command to unlock the door lock using 128 bits global IPv6 address say 1234::1/128. Further, the control command to unlock the door reaches the Wi-Fi router (WR) through the network. The WR forwards command to the BR1 as the door lock's destination IPv6 address 1234::1/128 matches with the first route entry in the routing table of the WR. The first border router (BR1) forwards the control command to the door lock taking the shortest route path determined by the processor in the WR.

In another example use case scenario, the UE sends a control command to switch ON the bulb in the living room. The application in the user equipment sends the control command to switch ON to the bulb in the living room using its 128 bits global IPv6 address say 1234::2/128. The control command from the UE reaches the Wi-Fi router through the network. The Wi-Fi router forwards command to the second border router (BR2) (208) as the bulb's destination IPv6 address 1234::2/128 matches with the second route entry in the routing table of the WR. The second border router (BR2) (208) forwards the control command in the downlink traffic packet to the bulb taking the shortest route path resulting in downlink performance improvement.

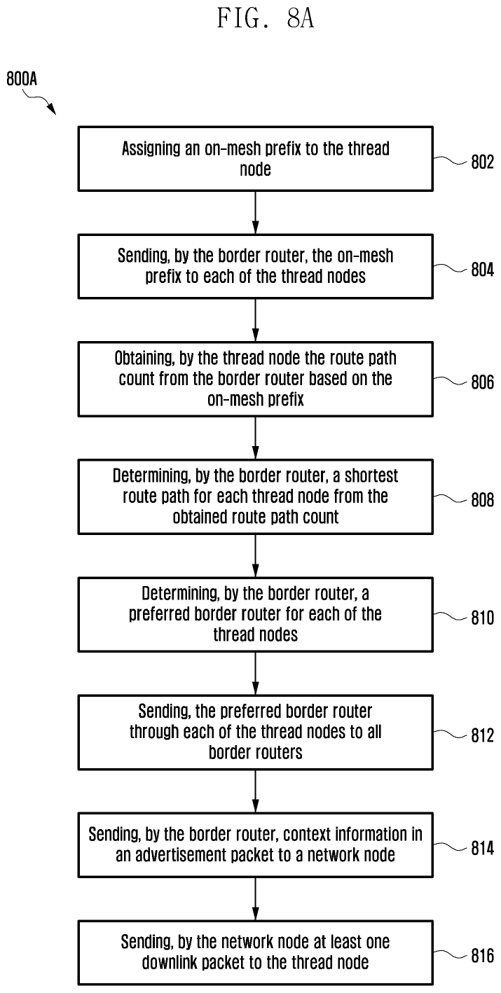

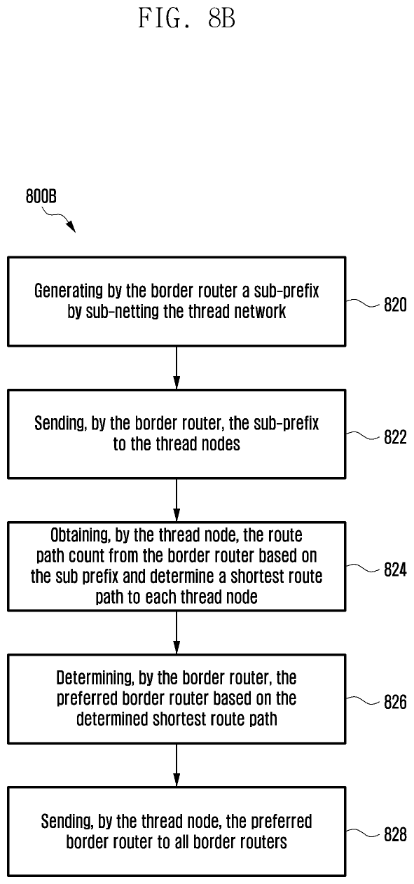

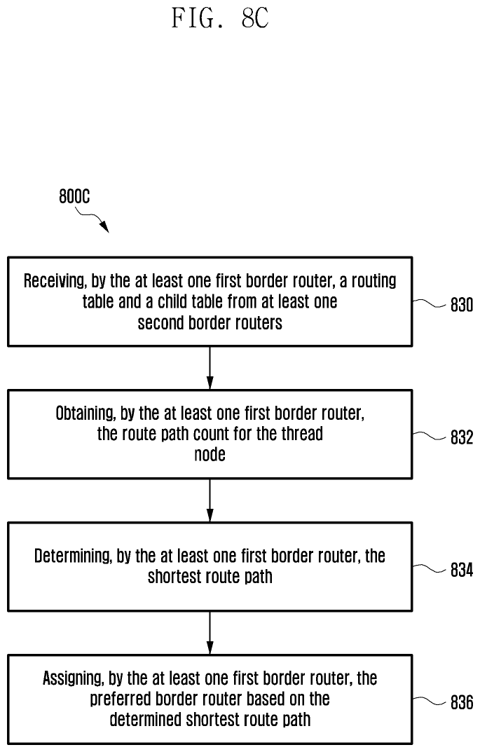

In an embodiment disclosed herein, FIG. 8A shows a method for routing the downlink traffic data in the IoT environment. The method comprises at step 802, the border router assigns the on-mesh prefix to the thread node. At step 804, the border router sends the on-mesh prefix to each of the thread nodes. At step 806, the thread nodes obtain the route path count from the border router based on the on-mesh prefix. The route path count is determined by the hop count that the border router takes to reach the thread node. In an embodiment herein, the route path count is determined by the round-trip time of a ping sent from the border router to each of the thread nodes. At step 808, the border router determines the shortest route path for each thread node from the obtained route path count. At step 810, the preferred border router for each of the thread nodes is determined based on the shortest route path count of each thread node from the border router. At step 812, each thread node sends the preferred border router to at least one border router. At step 814, the border router sends context information in an advertisement packet to a network node. The context information indicates the assigned preferred border router. At step 816, the network node sends at least one downlink packet to the thread node through the assigned preferred border router. The various actions in method 800A may be performed in the order presented, in a different order or simultaneously.

In an embodiment disclosed herein, FIG. 8B shows a method for routing the downlink traffic data in the IoT environment. At step 820, the border router generates a sub-prefix by sub-netting the thread network (230). At step 822, the border router sends the sub-prefix to the thread nodes. At step 824, the thread node obtains the route path count from each border router based on the respective sub-prefixes and determines a shortest route path to each thread node from the border router. At step 826, the border router determines the preferred border router from the determined shortest route path. At step 828, the thread node sends the determined preferred border router to all border routers. The various actions in method 800B may be performed in the order presented, in a different order or simultaneously.

In an embodiment disclosed herein, FIG. 8C shows a method for routing the downlink traffic data in the IoT environment, according to embodiments as disclosed herein. At step 830, the border router receives the routing table and a child table from one or more border routers. At step 832, the one or more border routers obtain the route path count for the thread node from the border routers. At step 834, the border router determines the shortest route path for the thread nodes. At step 836, the border router assigns the preferred border router to the thread node based on the determined shortest route path. The various actions in method 800C may be performed in the order presented, in a different order or simultaneously.

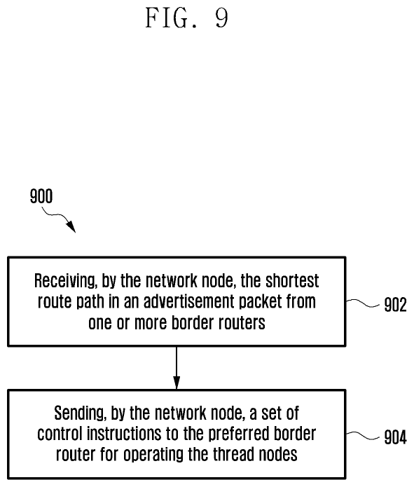

FIG. 9 depicts a method for downlink routing management in a thread network (230) in an Internet of Things (IoT) environment, according to embodiments as disclosed herein. At step 902, the network node receives the shortest route path in an advertisement packet from one or more border routers. The shortest route path comprises a preferred border router in a shortest route path to one or more thread nodes. At step 904, the network node sends a set of control instructions to the preferred border router for operating the thread nodes. The various actions in method 900 may be performed in the order presented, in a different order or simultaneously.

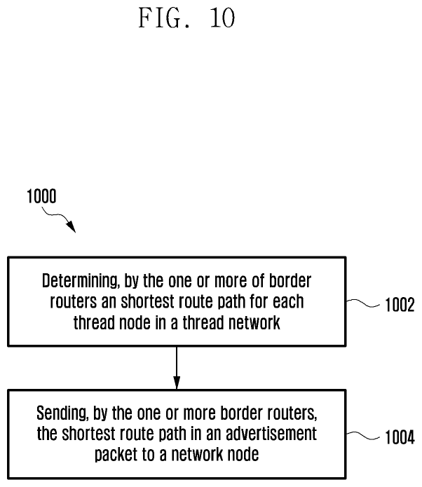

FIG. 10 depicts a method for downlink routing management in a thread network (230) in an Internet of Things (IoT) environment, according to embodiments as disclosed herein. At step 1002, the one or more border routers determines a shortest route path for each thread node in a thread network (230). At step 1004, the one or more border routers send the shortest route path included in an advertisement packet to a network node, the shortest route path relating to a preferred border router for following a minimum transmission path to one or more thread nodes. The various actions in method 1000 may be performed in the order presented, in a different order or simultaneously.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

What is claimed is:

1. A wireless network device, comprising:
at least one processor; and
memory storing instructions,
wherein the instructions, when executed by the at least one processor, individually or collectively, cause the wireless network device to:
control at least one border router to determine a shortest route path from the at least one border router to a thread node in a thread network;
control the at least one border router to assign a preferred border router to the thread node based on the shortest route path;
control the at least one border router to send context information in an advertisement packet to a network node, wherein the context information indicates the assigned preferred border router for the thread node; and
send at least one downlink packet to the thread node through the assigned preferred border router.

2. The wireless network device of claim 1, wherein the instructions, when executed by the at least one processor, individually or collectively, cause the wireless network device to:
control the at least one border router to assign an on-mesh prefix to the thread node;
control the at least one border router to send the on-mesh prefix to the thread node;
control the thread node to obtain a route path count from the at least one border router based on the on-mesh prefix;
control the thread node to send information identifying the preferred border router to the at least one border router; and
control the at least one border router to determine the shortest route path from the at least one border router to the thread node based on the obtained route path count.

3. The wireless network device of claim 1, wherein the instructions, when executed by the at least one processor, individually or collectively, cause the wireless network device to:
control the at least one border router to generate a sub-prefix by sub-netting the thread network;
control the at least one border router to send the sub-prefix to the thread node;
control the thread node to obtain a route path count from the at least one border router based on the sub-prefix;
control the thread node to send the preferred border router to the at least one border router; and
control the at least one border router to determine the shortest route path from the at least one border router to the thread node based on the obtained route path count.

4. The wireless network device of claim 1, wherein the instructions, when executed by the at least one processor, individually or collectively, cause the wireless network device to:
control at least one first border router to receive a routing table and a child table from at least one second border router;
control the at least one first border router to obtain a route path count for the thread node from the routing table and the child table; and
control the at least one first border router to determine a shortest route path from the at least one first border router to the thread node based on the obtained route path count.

5. The wireless network device of claim 4, wherein the routing table is populated with information identifying the thread node and a preferred border router for the thread node that is selected from among the at least one first border router and the at least one second border router.

6. The wireless network device of claim 1, wherein the instructions, when executed by the at least one processor, individually or collectively, cause the wireless network device to:
control the at least one border router to generate one or more route information options (RIOs) comprising the context information;
control the at least one border router to include the one or more route information options in an IPv6 router advertisement packet; and
control the at least one border router to send the IPv6 router advertisement packet to the network node.

7. The wireless network device of claim 2, wherein the instructions, when executed by the at least one processor, individually or collectively, cause the wireless network device to:
control the thread node to obtain route path counts from a plurality of border routers based on the on-mesh prefix;
control the thread node to assign a border router, from among the plurality of border routers, having a shortest route path to the thread node as a primary border router;
control the thread node to assign another border router, from among the plurality of border routers, as a backup border router;
control the thread node to send an uplink packet through the primary border router based on the primary border router being available; and
control the thread node to send an uplink packet through the backup border router based on the primary border router being unavailable.

8. The wireless network device of claim 7, wherein the instructions, when executed by the at least one processor, individually or collectively, cause the wireless network device to:
control the at least one border router to assign a primary on-mesh prefix to the thread node for communication through the primary border router;
control the at least one border router to assign a backup on-mesh prefix to the thread node for communication through the backup border router;
control the thread node to use the primary on-mesh prefix to send an uplink packet through the primary border router based on the primary border router being available; and
control the thread node to use the backup on-mesh prefix to send an uplink packet through the backup border router based on the primary border router being unavailable.

9. The wireless network device of claim 7, wherein the instructions, when executed by the at least one processor, individually or collectively, cause the wireless network device to:
control the at least one border router to assign a primary sub-prefix to the thread node for communication through the primary border router;
control the at least one border router to assign a backup sub-prefix to the thread node for communication through the backup border router;
control the thread node to use the primary sub-prefix to send an uplink packet through the primary border router based on the primary border router being available; and
control the thread node to use the backup sub-prefix to send an uplink packet through the backup border router based on the primary border router being unavailable.

10. The wireless network device of claim 1, wherein the instructions, when executed by the at least one processor, individually or collectively, cause the wireless network device to:
control the at least one border router to calculate a first route path count for the thread node based on a hop count from the at least one border router to the thread node;
control the at least one border router to calculate a second route path count for the thread node based on a round-trip time from the at least one border router to the thread node; and
control the at least one border router to determine the shortest route path from the at least one border router to the thread node based on at least one of the first route path count and the second route path count.

11. A method for routing downlink data packets in a thread network, the method comprising:
determining, by at least one border router, a shortest route path from the at least one border router to a thread node in a thread network;
assigning, by the at least one border router, a preferred border router to the thread node based on the determined shortest route path;
sending, by the at least one border router, context information in an advertisement packet to a network node, wherein the context information indicates the assigned preferred border router for the thread node; and
sending, by the network node, at least one downlink packet to the thread node through the assigned preferred border router.

12. The method as claimed in claim 11, wherein the determining the shortest route path comprises:
assigning, by the at least one border router, an on-mesh prefix to the thread node;
sending, by the at least one border router, the on-mesh prefix to the thread node;
obtaining, by the thread node, a route path count from the at least one border router based on the on-mesh prefix;
sending, by the thread node, information identifying the preferred border router to the at least one border router; and
determining, by the at least one border router, the shortest route path from the at least one border router to the thread node based on the obtained route path count.

13. The method as claimed in claim 11, wherein the determining the shortest route path comprises:
generating, by the at least one border router, a sub-prefix by sub-netting the thread network;
sending, by the at least one border router, the sub-prefix to the thread node;
obtaining, by the thread node, a route path count from the at least one border router based on the sub-prefix;
sending, by the thread node, information identifying the preferred border router to the at least one border router; and
determining, by the at least one border router, the shortest route path from the at least one border router to the thread node based on the obtained route path count.

14. The method as claimed in claim 11, wherein the determining the shortest route path comprises:
receiving, by at least one first border router, a routing table and a child table from at least one second border router;
obtaining, by the at least one first border router, a route path count for the thread node from the routing table and the child table; and
determining, by the at least one first border router, a shortest route path from the at least one first border router to the thread node based on the obtained route path count.

15. The method as claimed in claim 14, wherein the routing table is populated with information identifying the thread node and a preferred border router for the thread node that is selected from among the at least one first border router and the at least one second border router.

16. The method as claimed in claim 11, wherein the sending the context information comprises:
generating, by the at least one border router, one or more route information options comprising the context information;
including, by the at least one border router, the one or more route information options (ROIs) in an IPv6 router advertisement packet; and
sending by the at least one border router, the IPv6 router advertisement packet to the network node.

17. The method of claim 12, wherein the determining the shortest route path comprises obtaining, by the thread node, route path counts from a plurality of border routers based on the on-mesh prefix,
wherein the assigning the preferred border router comprises:
assigning, by the thread node, a border router, from among the plurality of border routers, having a shortest route path to the thread node as a primary border router; and
assigning, by the thread node, another border router, from among the plurality of border routers, as a backup border router, and
wherein the method further comprises:
sending, by the thread node, an uplink packet through the primary border router based on the primary border router being available; and
sending, by the thread node, an uplink packet through the backup border router based on the primary border router being unavailable.

18. The method of claim 17, wherein the assigning the on-mesh prefix comprises:
assigning, by the at least one border router, a primary on-mesh prefix to the thread node for communication through the primary border router; and
assigning, by the at least one border router, a backup on-mesh prefix to the thread node for communication through the backup border router, and
wherein the method further comprises:
using, by the thread node, the primary on-mesh prefix to send an uplink packet through the primary border router based on the primary border router being available; and
using, by the thread node, the backup on-mesh prefix to send an uplink packet through the backup border router based on the primary border router being unavailable.

19. The method of claim 17, wherein the assigning the on-mesh prefix comprises:
assigning, by the at least one border router, a primary sub-prefix to the thread node for communication through the primary border router; and
assigning, by the at least one border router, a backup sub-prefix to the thread node for communication through the backup border router, and
wherein the method further comprises:
using, by the thread node, the primary sub-prefix to send an uplink packet through the primary border router based on the primary border router being available; and
using, by the thread node, the backup sub-prefix to send an uplink packet through the backup border router based on the primary border router being unavailable.

20. A non-transitory computer-readable recording medium having at least one instruction recorded thereon, that, when executed by at least one processor, individually or collectively, cause the at least one processor to:
control at least one border router to determine a shortest route path from the at least one border router to a thread node in a thread network;
control the at least one border router to assign a preferred border router to the thread node based on the shortest route path;
control the at least one border router to send context information in an advertisement packet to a network node, wherein the context information indicates the assigned preferred border router for the thread node; and
send at least one downlink packet to the thread node through the assigned preferred border router.
